(19) United States
(12) Patent Application Publication
(10) Pub. No.: US 2016/0318273 A1
(43) Pub. Date: Nov. 3, 2016

(54) METHOD FOR RETREADING A TIRE CASING USING DEPRESSION

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Jose MERINO LOPEZ, Clermont-Ferrand (FR); Cedric ASTIER, Clermont-Ferrand (FR)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/107,754

(22) PCT Filed: Dec. 18, 2014
(86) PCT No.: PCT/FR2014/053416

§ 371 Date: Jun. 23, 2016

(30) Foreign Application Priority Data
Dec. 23, 2013 (FR) 1363450

(51) Int. Cl. B29D 30/56

(52) U.S. Cl. CPC B29D 30/56; B29K 2021/003

(57) ABSTRACT

A method for retreading a tire casing is disclosed herein. The method includes at least the following steps: an internal volume of a casing carcass is put under negative pressure, a vulcanized tread closed in the form of a ring is provided, and—the tread is laid on the carcass.

### CROSS-REFERENCE TO RELATED APPLICATIONS

This application is a 371 national phase entry of PCT/FR2014/053416, filed 18 Dec. 2014, which claims the benefit of French Patent Application No. 1363450, filed 23 Dec. 2013, the contents of which are incorporated herein by reference for all purposes.

### BACKGROUND

The disclosure relates to the retreading of tires.

The retreading operation conventionally consists in removing the worn tread from a tire casing in order to replace it with a new tread. To this end, it is known practice to provide the tire with a hot-melt bonding layer that bonds the tread to the carcass. With a view to retreading, the bonding layer is heated and softens, thereby making it easy to remove the tread. Next, a tread that is compatible with use on a wheel is laid. Next, this layer is heated to a predetermined temperature that is characteristic of the material so as to soften it, and then it is allowed to cool. On cooling, the layer ensures the adhesion of the tread to the carcass.

When the tread is closed in the form of a ring, it is necessary to deform the tread or the carcass before it is possible to lay the tread on the carcass, given that these two parts have virtually identical radii.

To this end, it is known practice to stretch such a tread in order to increase its radius. However, such a method is not conceivable if the tread comprises reinforcements which make it virtually inextensible.

It is also known practice to collapse the carcass with the aid of mechanical arms which press on the external surface thereof and exert a radial force towards the centre of the tire. When a hot-melt layer is used, this action can damage the layer, in particular during the extraction of the arms once the tread has been laid on the carcass.

### SUMMARY

The aim of the disclosure is to improve the laying of the tread.

To this end, a method for retreading a tire casing is provided according to the disclosure, wherein:
an internal volume of a casing carcass is put under negative pressure,
a vulcanized tread in the form of a closed ring is provided, and
the tread is laid on the carcass,

the carcass and/or the tread bearing a thermoplastic or hot-melt bonding layer.

Thus, the radius of the carcass is reduced instead of that of the tread being increased, thereby making it possible to overcome the inextensibility of the latter, even if the carcass comprises reinforcements.

In one embodiment, before the internal volume of the carcass is put under negative pressure, said carcass is mounted on a rim.

Such an installation thus makes it easier to put the internal volume of the carcass under negative pressure.

Advantageously, the negative pressure is brought about by lowering a pressure in the internal volume by at least 0.5×10³ Pa, and preferably by at least 0.8×10⁵ Pa.

According to one embodiment, lobes are generated on the carcass.

Thus, such lobes make it possible to considerably reduce the radius of the carcass and make it even easier to lay the tread.

Advantageously, pressure is applied to at least one point on an external face of the carcass.

Preferably, the pressure is applied by means of a member and the member is removed before the laying step.

Damage to the casing is thus avoided when the member is removed.

Depending on the nature of the material of which the carcass is made, the formation of the lobes can take place naturally while the internal volume of the carcass is being put under negative pressure, without external action. In other cases, it is necessary for this purpose to apply an external pressure at one or more points on the carcass.

According to one embodiment, the tread has a longitudinal rigidity greater than 1 GPa.

The tread thus has a role of mechanical hooping during rolling.

Advantageously, the bonding layer is heated.

Thus, by carrying out heating before laying the tread, the bonding layer is in the pasty state when laying is carried out.

Preferably, the bonding layer comprises a thermoplastic elastomer.

According to one embodiment, after the tread has been laid on the carcass, the latter is inflated.

The carcass then returns to its original shape and is pressed against the tread. At this time, the bonding layer is pressed firmly and pressurized between these two parts. On cooling to a temperature lower than its melting point, it creates the adhesion of the tread to the carcass. The tire casing is then ready to be mounted on a wheel.

A tire casing which has undergone a retreading operation according to the disclosure is also provided.

### BRIEF DESCRIPTION OF THE DRAWINGS

An embodiment of the disclosure will now be presented with reference to the appended drawings, in which:

FIG. 1 is a view in radial section of a tire casing that undergoes a method according to one embodiment of the disclosure;

FIGS. 2 and 3 are views in radial and longitudinal section, respectively, of the positioning of the tread with respect to the carcass while the latter is under negative pressure; and

FIG. 4 is a view in axial section of the casing from FIG. 1 and of a device for putting under negative pressure.

### DETAILED DESCRIPTION

An embodiment of the disclosure, which consists in retreading a wheel tire casing, will be described.

Prior to this embodiment, a tire casing comprising a carcass and a tread is provided. When the latter has become worn, it is necessary to remove it before fitting a new tread. When the casing is provided with a bonding layer comprising a thermoplastic or hot-melt material, the layer is heated until it softens, thereby losing its adhesive property. It is thus possible to grasp the tread and separate it entirely from the rest of the casing by peeling.

The naked carcass then undergoes the retreading method.

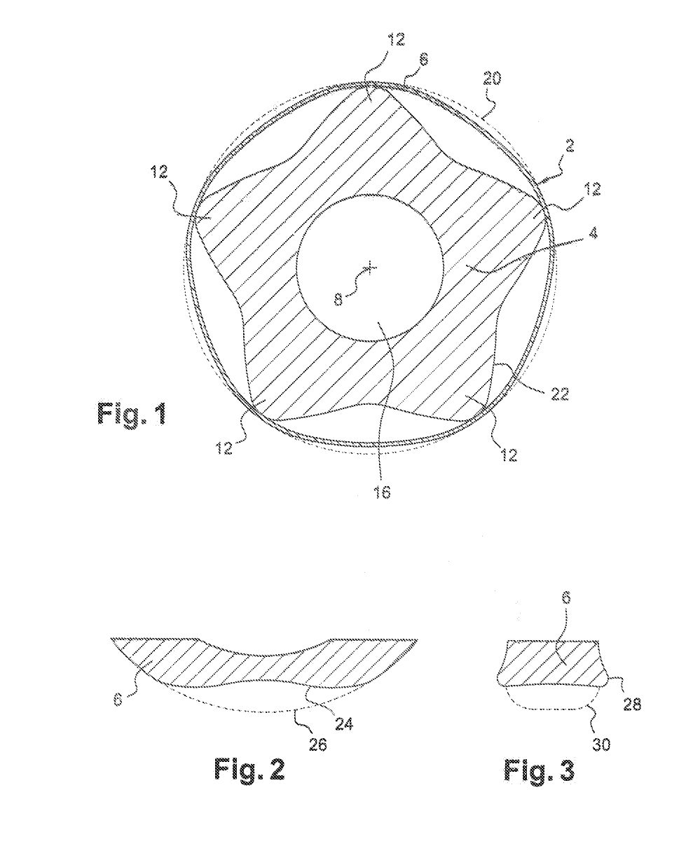

For this, with reference to FIG. 1, the carcass 4 of the tire casing 2 is mounted on a rim 16. An external surface of the carcass then follows a toroidal circular contour 20.

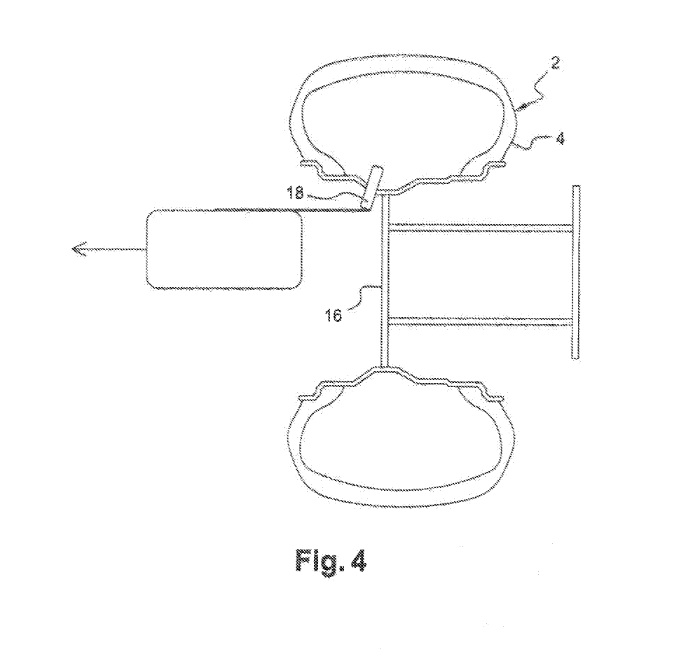

Next, a device 18 illustrated in FIG. 4, for example a venturi vacuum pump, is used to create a negative pressure in an internal volume of the carcass. Depending on the composition of the latter, in particular the number and type of any reinforcers that it may comprise and its thickness, lobes 12 can form naturally on the carcass. The number of lobes thus formed varies depending on the geometric parameters of the carcass and on its composition. However, if they do not appear naturally, a pressure is manually applied locally at at least one point on the carcass in order to force their formation. The presence of five lobes can be seen in FIG. 1. By way of example, with a carcass formed by the following plies:
a carcass ply provided with reinforcers at 90° made of textile, in particular nylon, rayon, polyester or polyethylene terephthalate (PET),
a ply provided with steel reinforcers at an angle of between 20 and 50°, and
a ply provided with reinforcers at 0° made of nylon, rayon, PET, metal or aramid, and having the dimensions 115/85 RI2, the natural formation of six lobes is obtained. There is no need to apply an external pressure to the carcass in order to induce their formation. On the other hand, with a carcass that does not comprise one but rather two plies provided with steel reinforcers at an angle in addition to the two other plies described above, the lobes 12 do not form naturally and the application of an external pressure towards the centre of the carcass is necessary.

Once the lobes have formed, the external surface of the carcass follows a new contour 22 having an overall star shape.

A vulcanized tread 6, in the form of a closed ring, provided with a bonding layer 10 on an internal face is then provided, it being possible for said tread to have a radius slightly smaller than that of the carcass. In this case, it is a layer made of a hot-melt material known per se.

A hot-melt material is understood to be a material that is able to soften when it is heated in order to be brought to a predetermined temperature that is characteristic of the material, known as the softening temperature. For example, such a material can be chosen from thermoplastic elastomers such as SBS (stirene-butadiene-stirene) or SIS (stirene-isoprene-stirene). For the purposes of the disclosure, reference is made to a hot-melt material that is capable of softening at a temperature of between 140° C. and 200° C.

This bonding layer is heated to a sufficient temperature for it to be in a pasty state. The heating can be carried out for example by infrared radiation.

The tread is then laid on the carcass by grasping it by its external face. It will be readily understood that the putting of the carcass under negative pressure and the lobes formed considerably reduce the size of the carcass, as indicated by the contours 20 and 22, and thus that there is no need to excessively stretch the tread, which can thus comprise reinforcers having a rigidity greater than 70 MPa.

On the other hand, on account of the shape of the carcass under negative pressure, the tread undergoes deformations when it is placed thereon. With reference to FIG. 2, which shows the casing from the side, it will be noted that the tread deforms towards the inside of the casing, its external surface following a contour 24 different from the contour 26 it would adopt if the carcass were in its initial shape. With reference to FIG. 3, which shows a partial axial section of the casing, it will be noted that the sidewalls of the tread deform towards the outside of the casing but only in the shoulder regions, its external surface following a contour 28 different from the contour 30 it would adopt if the carcass were in its initial shape.

Once the tread has been positioned on the carcass, the latter is inflated in order to assemble the casing. The bonding layer, still in the pasty state, is then pressed firmly and compressed between the carcass and the tread. It is allowed to cool to a temperature below its melting point, thereby creating the adhesion of the assembly. The casing is then removed from the rim.

The casing can then be mounted on a wheel.

Of course, numerous modifications may be made to the disclosure without departing from the scope thereof.

The bonding layer can comprise a hot-melt material other than a thermoplastic elastomer.

The carcass can be provided with a hot-melt bonding layer, instead of or in addition to the one on the tread.

The carcass can have any other architecture and other dimensions.

A different number of lobes can be formed on the carcass when it is put under negative pressure.

1. A method for retreading a tire casing, comprising:
putting an internal volume of a casing carcass under negative pressure,
providing a vulcanized tread in the form of a closed ring, and
laying the tread on the carcass, wherein
the carcass and/or the tread bearing a thermoplastic or hot-melt bonding layer (10).

2. The method according to claim 1, wherein, before the internal volume of the carcass is put under negative pressure, said carcass is mounted on a rim.

3. The method according to claim 1, wherein the negative pressure is brought about by lowering a pressure in the internal volume by at least 0.5×10⁵ Pa, and preferably by at least 0.8×10⁵ Pa.

4. The method according to claim 1, wherein lobes are generated on the carcass.

5. The method according to claim 1, wherein pressure is applied to at least one point on an external face of the carcass.

6. The method according to claim 1, wherein the pressure is applied by means of a member and the member is removed before the laying step.

7. The method according to claim 1, wherein the tread has a longitudinal rigidity greater than 1 GPa.

8. The method according to claim 1, wherein the bonding layer is heated.

9. The method according to claim 1, wherein the bonding layer comprises a thermoplastic elastomer.

10. The method according to claim 1, wherein, after the tread has been laid on the carcass, the latter is inflated.
